(19) United States
(12) Patent Application Publication
(10) Pub. No.: US 2002/0056116 A1
(43) Pub. Date: May 9, 2002

(54) Home bus computer system and method

(76) Inventor: Wesley Smith, Raleigh, NC (US)

Correspondence Address: Robert Platt Bell, 8033 Washington Road, Alexandria, VA, 22308, US

(21) Appl. No.: 09/816,103

(22) Filed: Mar. 26, 2001

Related U.S. Application Data
(60) Provisional application No. 60/192,939, filed on Mar. 29, 2000.

(51) Int. Cl. H04N 7/173

(52) U.S. Cl. 725/86

(57) ABSTRACT

The present invention provides a network which includes a server, power bus, and at least a single terminal for asymmetrically communicating with the server over broadband and narrowband channels using modem technology. Broadband communication may include transmitting video change data for display on at least a single terminal monitor. Narrowband communication may include transmitting keyboard and mouse data to a server for control of application programs either prior to or after runtime. The use of this asymmetric modem communication techniques, as opposed to network technology, allows a large amount of data to be transmitted over a limited bandwidth network, such as home powerlines.

### CROSS-REFERENCE TO RELATED APPLICATIONS

The present application claims priority from Provisional U.S. patent application Ser. No. 60/192,939 filed on Mar. 29, 2000, and incorporated herein by reference.

### FIELD OF THE INVENTION

The present invention relates to multi-mode network communication systems and methods. In particular, the present invention is directed toward an asymmetric multi-mode network communication systems and methods which operate over an electrical power system having a predetermined single local voltage level such as is common for a home power bus.

### BACKGROUND OF THE INVENTION

Network computer systems have been developed or proposed in which a plurality of users may be connected in a digital network operating with one or more servers performing the bulk of operating system and applications processing. In such “thin client” applications, the users may employ terminals which may have limited data processing capabilities but are still capable of communicating with the network servers. Such systems may result in user access to network processing power at a relatively low terminal cost. Unfortunately, such a network system remains costly because conventional network wiring and protocols (such as Ethernet) are contemplated.

In addition to systems such as described above, other uses of local networks have been implemented or proposed. For example, the advent of so-called Internet appliances has created a demand for networking capabilities not only between traditional computer stations, but also between other computer enhanced appliances, such as entertainment equipment, radios, office equipment (photocopiers and the like) and even more traditional appliances such as refrigerators and other kitchen appliances.

In the home or office of the future, many appliances may interface with a network server which in turn may provide a data path for the appliances to the Internet (i.e., via cable modem, ISDN line, fiber optic connection, or the like). However, as noted above, traditional Ethernet and other network connections (e.g., 10baseT, or the like) may be somewhat expensive to implement. A separate hub connection for each appliance would require a network interface and separate wire. In addition, the home or office would have to be wired with network wiring for each appliance. Even homes constructed today with built-in network wiring do not anticipate such widespread use of network connections for even simple appliances.

Most user sites, however, are interconnected by a common electric power bus operating at a predetermined single local voltage level (e.g., 110 VAC 60 Hz for North America, 220 VAC 50 Hz “mains” in Europe). Accordingly it is desirable to employ the local electric power bus to effect user terminal interconnections without incurring the expense and inconvenience of a separate data wiring installation and maintenance.

Recent Developments in the Art

Since the filing of applicant's Provisional Application, a number of developments have occurred in the art. The following discussion of these developments is not provided as a discussion of Prior Art per se, as applicant is unaware whether such developments antedate the conception date of the present invention. Thus, the following discussion is not to be construed as an admission that any of these technologies qualify as “Prior Art” to applicant's invention.

Sending data or control signals over power lines per se is known. For example, products exist on the market which will transmit lighting control signals or even telephone or intercom signals over a 100 VAC 60 Hz power line. Some limited experiments have been used or proposed to transmit data over power lines in home networks. For example, Enikia Corporation of Warren, New Jersey (www.enikia.com) claims to have developed a technique for using home powerlines for Ethernet networking purposes. However, from their website, it is not clear whether a working product has been developed.

Indeed, many have viewed household power wiring as a way of providing networking capabilities within the home. The HOMEPLUG alliance (www.homeplug.com), for example, was created to develop standards for home power line communications. Intellon, of Ocala, Fla. (www.intellon.com) also is developing devices for communicating over home power lines. However, again, it does not appear that products, other than integrated circuits, are yet ready for the marketplace.

Intelogis, of Draper, Utah (www.intelogis.com) appears to be one of the few companies to be shipping actual home powerline networking products. However, according to a recent on-line article of Aug. 14, 1999 in Technocopia, the product is not without its limitations. In particular, the limited bandwidth of the product has been noted as a limitation to implementation. It is not clear what the future of this product will be. Intelogis has announced it is changing its name to “Inari” and focusing more on home communications chipsets (see, www.inari.com) rather than actual products.

Perhaps one reason why these products have not yet reached the marketplace in large numbers is the inherent noise and limited bandwidth of home power lines. In addition to the 60 Hz power signal, various voltage spikes and surges are introduced each time a large inductive load (e.g., refrigerator motor, air conditioner, or the like) is switched on. Sampling a power line signal in the home over a given time period will show an alarming number of surges, voltage sags, spikes, and other transients which may interfere with high-speed communications. These proposed products appear to be attempts to take existing “full blown” Ethernet LAN type networks and adapt them to power line usage. Given the bandwidth of such traditional Ethernet LANs and the inherent noise problems of powerlines, it could be a significant problem to introduce TCP/IP type protocols over a 60 Hz powerline.

However, such techniques may not be necessary for most home networking communications. For example, in a thin client environment, user terminals may send only limited amounts of data (keystrokes, mouse clicks and moves) upstream to a server. The return data would generally be video display data or printer data (e.g., to a networked printer or the like). Even for so-called Internet appliances, such as an Internet-compatible radio, the amount of bandwidth needed to play digital music may be limited. Thus, implementing a full Ethernet-type protocol on a home power line may be unnecessary.

Accordingly, a need exists in the art to provide a communication technique for transmitting data between a server and terminals within a site, using existing powerline wiring, while adapting the communication techniques to the limitations of such wiring.

### SUMMARY OF THE INVENTION

The present invention solves the problems of the Prior and contemporary art by providing a network which includes a server, power bus, and at least a single terminal for asymmetrically communicating with the server over broadband and narrowband channels. Broadband communication may include transmitting video change data for display on at least a single terminal monitor. Narrowband communication may include transmitting keyboard and mouse data to a server for control of application programs either prior to or after runtime. The use of this asymmetric communication technique allows a large amount of data to be transmitted over a limited bandwidth network, such as home powerlines.

The server may include a modem configured for transmission of broadband video change data and reception of narrowband keyboard and mouse information. The terminal may include a modem configured for reception of broadband video change data and reception and transmission of narrowband keyboard and mouse information. The server may be booted and await a wakeup call from a terminal. When a terminal is activated, a preselected message may be selected to boot the server operating system. A user may then select an application program to be run on the server under remote user control over the electric power system.

### BRIEF DESCRIPTION OF THE DRAWINGS

FIG. 1A is a block diagram of a home bus computing network system according to the present invention, including a server system, a plurality of remote terminal systems interconnected with each other and the server over a power main.

FIG. 1B is a block diagram of details of a selected remote terminal system including a monitor, keyboard, and mouse elements.

FIG. 1C is a detailed block diagram of a home bus computer network system including a server system, a plurality of remote terminal systems interconnected with each other over a power main.

FIG. 1D is a block diagram illustrating a geographical layout of a home bus system environment including a source of electrical power, power meter, main switch box, and home bus system.

FIG. 2 is a block diagram of a portion of the server system including a main circuit board, modem, and details of the power main interface.

FIG. 3 is a block diagram of a portion of a remote terminal system including a transformer circuit and a home bus client modem.

FIG. 4 is a block diagram of a terminal system including a keyboard, a home bus client modem system, a power outlet connected to the home bus client modem system and to and from the main power bus, a video driver, a monitor and a mouse.

FIG. 5 is a flow chart describing system boot-up of the computer network system of the present invention.

### DETAILED DESCRIPTION OF THE INVENTION

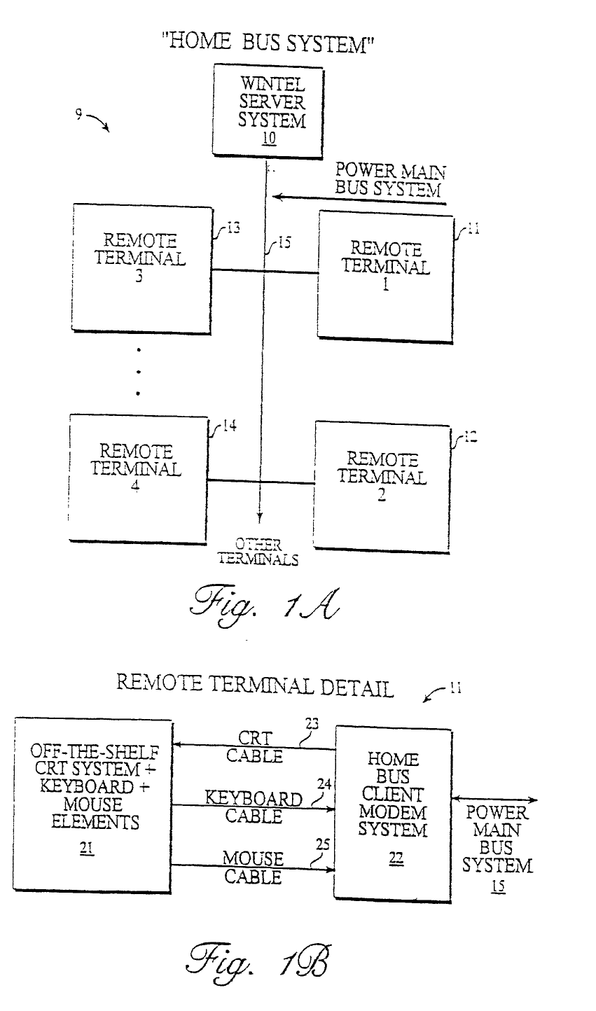

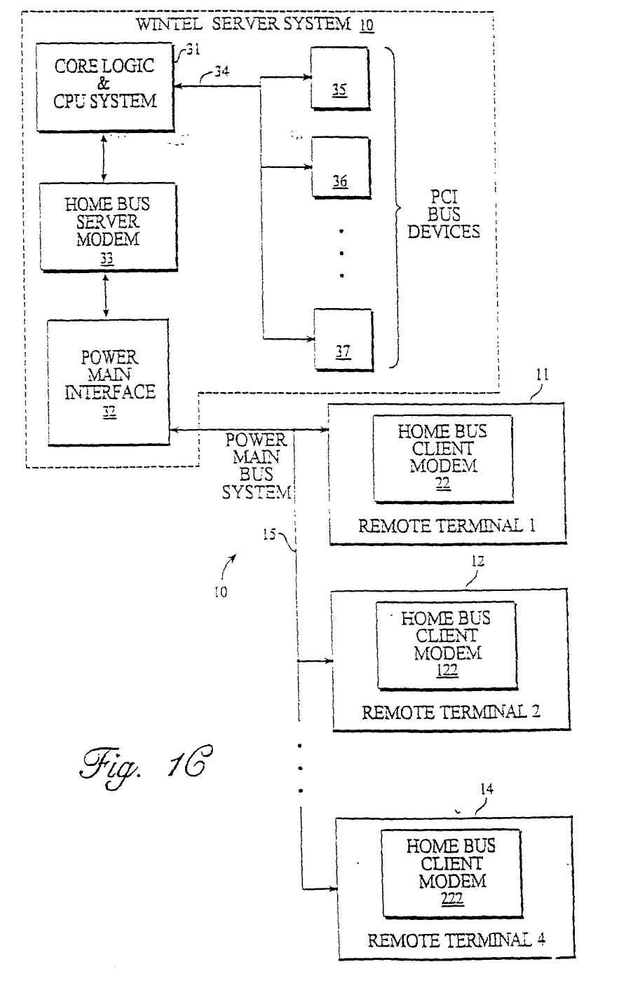

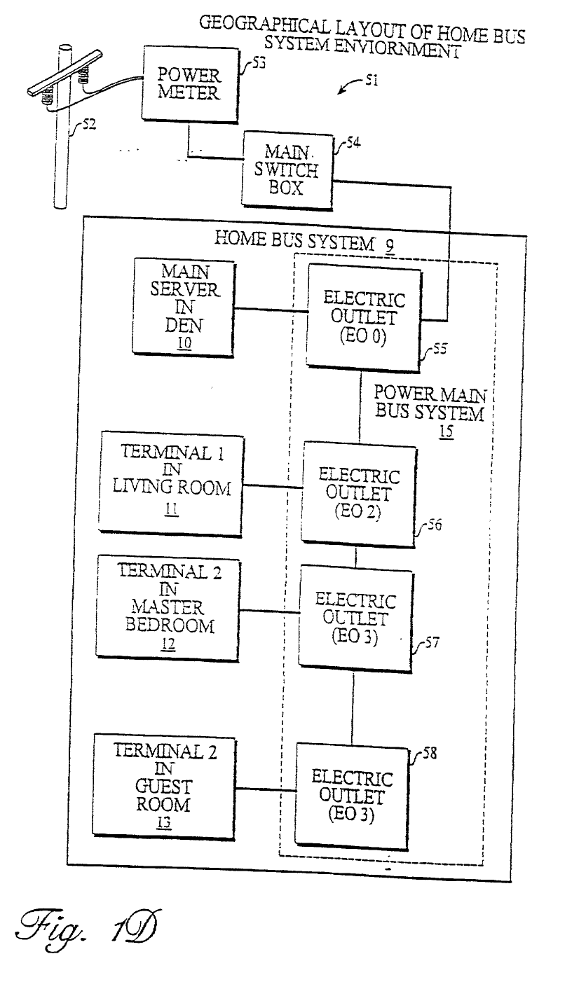

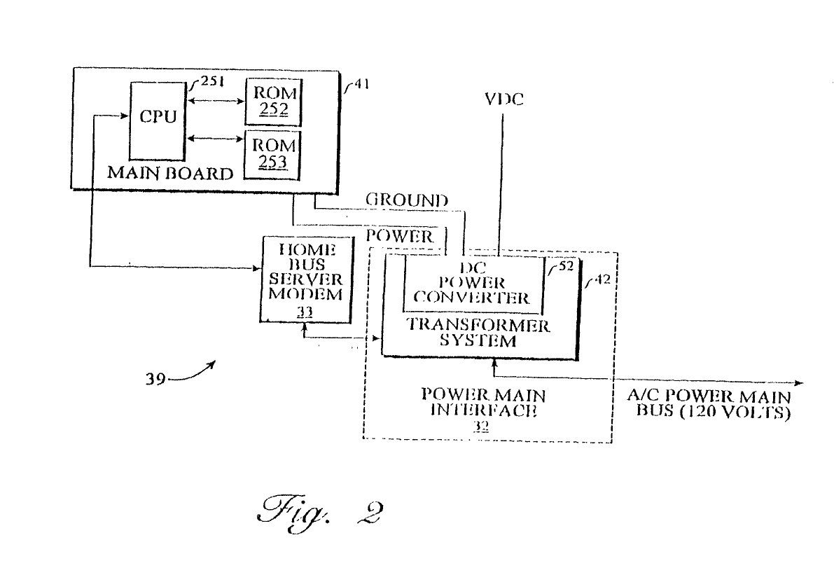

FIG. 1A is a block diagram of a home bus computer network system 9 according to the present invention, including server system 10, which may include, for example, an Intel processor (e.g., Pentium II, Pentium III, or the like) running, for example, at 300 MHz with, for example, a Windows 98 or higher operating system. Other types of processors (e.g., Motorola, AMD, or the like) may also be applied within the spirit and scope of the present invention. Similarly, other types of operating systems may also be used (e.g., Macintosh™ OS, UNIX, LINUX, or the like) without departing from the spirit and scope of the present invention.

A plurality of remote terminal systems 11, 12, 13, and 14 may be provided, interconnected with one another and server system 10 over power bus system 15 (e.g., power main) installed in a facility in which home bus computer network system 9 resides. Power bus system 15 includes an electric power bus providing alternating electric power in the form of a selected alternating voltage and current to server system 10 and the plurality of terminal systems 11, 12, 13, and 14. Note that the number of terminal systems illustrated (i.e., four) is by way of example only. any number of terminal systems (zero or more) may be provided within the spirit and scope of the present invention.

Power bus system 15 may further include a corresponding plurality of electric outlets enabling server system 10 and selected one of terminal systems 11, 12, 13, and 14 to be interconnected with one another. Server system 10 and terminal systems 11, 12, 13, and 14 may communicate with one another by signals superimposed over the power waveforms expressed in the power main bus system, as will be described in more detail below. In the United States, for example, common power waveforms alternate at approximately 60 cycles per second between peak to peaks voltage levels of approximately 110 volts. The superimposed signals according to the present invention have a higher frequency than the power waveforms.

FIG. 1B is a block diagram illustrating details of a selected remote terminal system including a monitor (e.g., CRT), keyboard, and mouse elements 21, associated respective CRT, keyboard, and mouse cables 23, 24, and 25, and a home bus client modem 22 coupled to power bus system 15. Monitor, keyboard, and mouse elements 21 may comprise off-the-shelf Prior Art components with little or no modification in order to reduce cost of implementation of the system of the present invention.

The respective CRT, keyboard, and mouse cables 23, 24, and 25 may have asymmetric signals bandwidths. In other words, signal carrying capacities for these cables may not be uniform. For example, the bandwidth of CRT cable 23 may be substantially greater than either of the bandwidths of keyboard and mouse cables 24 and 25. Moreover, the direction of signals for information travelling through CRT cable 23 (i.e., video data) is opposite to that of information travelling in keyboard and mouse cables 24 and 25. Thus, signals travelling “upstream” from a remote terminal (i.e., mouse and keyboard signals) may comprise a much smaller portion of data traffic than corresponding “downstream” signal (e.g., video data).

CRT cable 23 may carry video data which has been decompressed in homebus client modem system 22 from video data representing is changes in a matrix of pixel values representing locations on the CRT displays. Such video compression techniques are known in the art and may comprise, for example and without limitation, MPEG or MPEG II type encoding. In such encoding, frames of video data representing an image may be transmitted, followed by intermediate frames which represent only change data (i.e., those portions of the image which have changed from the previous frame). Despite the signal compression involved in providing only change data on CRT cable 23, the volume of change data is nonetheless substantially more than the volume of keyboard and mouse data transmitted in the opposite direction. The home bus client modem system 22 selectively codes and/or compresses signals from the mouse and keyboard for transmission over the power bus system 15 and is further configured to selectively decode and/or decompresses signals from the power bus system 15 to cause changes in the CRT display.

FIG. 1C is a detailed block diagram of the home bus computer 10 network system 9 of the present invention. Server system 10, as set forth above, may include an Intel™ Pentium™ processor or equivalent, operating Microsoft™ Windows™ type software. A plurality of remote terminals 11, 12, 13, and 14 may be connected to one another and the server system via power bus system 15. Server system 10 may include a core logic and central processing unit (CPU) system 31, a power main interface 32, a home bus server modem 33, an internal PCI bus 34, and a plurality of PCI bus devices 35-37.

Power main interface 32 includes a transformer system 42 for stepping up and stepping down the voltage of selected modular power waveforms. Home bus server modem 33 decode/decompresses narrowband mouse and keyboard signals received from remote terminals 11, 12, . . . ,14 which were coded/compressed on respective home client bus modems 22, 122,.,222. Home bus server modem 33 may code/compress broadband change signals to video data pixels to be presented in one or more of the remote terminals at their respective monitors.

FIG. 1D is a block diagram of the geographical layout of a home bus system environment 51, including source of electric power 52, power meter 53, main switch box 54, and home bus system 9 according to the present invention. Source of electric power 52 may comprise, for example, an electric power supply from an electric utility power pole or the like. Power meter 53 may in turn be connected to a main switch box 54 which is further connected to power bus system 15 in home bus system 9.

Power bus system 15 may include a number of electrical outlets (EO0 through EO4) respectively 55, 56, 57, and 58. Power bus system 15 may be connected to the main server located, for example, in the den of a home, of home bus system 9, at electric outlet 55. Power bus system 15 may be connected to first terminal system 11 in a living room, for example, second terminal system 12 in a master bedroom, third terminal system 13 in a guest room, and so on, via electric outlets 56, 57, and 58. Other numbers and locations of terminals may be used within the spirit and scope of the present invention.

FIG. 2 is a block diagram of a portion of the server system including a main circuit board, modem, and details of the power main interface. Server system 39 may include a main circuit board 41, a modem 33, and power main interface 32. Main circuit board 41 may include a central processing unit 251, random access memory (RAM) 252, and read-only memory (ROM) 253. Server 39 may further include a home bus server modem 33 and power main interface 32 which may further include a transformer system 42 and power converter 52.

Home bus server modem 33 may be coupled between CPU 251 and transformer system 42. Power bus system 15 carries alternating current (AC) and may have a 120 volt potential level, which is provided to transformer system 42. Main circuit board 41 is provided with DC power and a ground connection from DC power converter 52. Selected applications may run on CPU 251 to produce video display signals which may be carried to modem 33 for broadband modulation onto transformer system 42 and transmission over power bus system 15. Narrowband mouse and keyboard signals may be carried in coded and/or compressed form over power main bus 15 for voltage conversion in transformer system 42 and decoding/decompression in modem 33, to be sent to CPU 251 to influence performance of application code which is to run or is running on CPU 251.

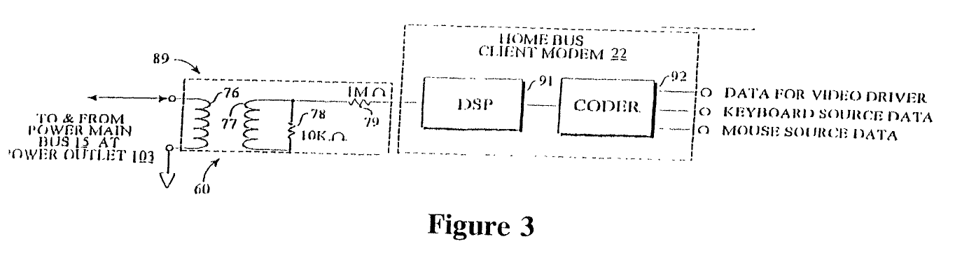

FIG. 3 is a block diagram of a portion of a remote terminal system including a transformer circuit and a home bus client modem. Portion 89 of remote terminal system 11 may include a transformer circuit 60 and a home bus client modem 22. Transformer circuit 60 may include a primary coil 76, a secondary coil 77, an 10 kΩ secondary coil parallel resistor 78 and a 1 MΩ secondary series resistor 79. Home bus client modem 22 may comprise a Discrete Multi Tone DSL type modem and may include a digital signal processor (DSP) 91 and coder circuit 92. DSP 91 may be connected between transformer circuit 60 and coder circuit 92.

Coder circuit 92 provides decoded/decompressed broadband data for a video driver, and receives uncoded keyboard source data and mouse source data, for coding and DSP processing in DSP 91 for transmission through transformer circuit 60 to power bus system 15 at power output 103. Broadband data for the video driver is received in coded form over power bus system 15 through transformer circuit 60 for processing by DSP 91 and decoding into coder circuit 92. Broadband data for the video driver may be code division multiplexed (CDMA) to divide the data stream among the clients. In the upstream direction (client to server) keyboard and/or mouse data may be transmitted using an ADSL type of spectral mask assigning specific sets of carrier frequencies to specific clients.

The embodiment of FIG. 3, using limited and asymmetric data paths may allow the use of “thin client” operations over the limited bandwidth of a powerline based network. In particular, as noted above, the signals from a client to a server may be very limited (keyboard entries and mouse movements) whereas the data from the server to the client may be much larger (video displays) By reducing the video data to a video pixel change information, bandwidth may be further reduced. Thus, the embodiment of FIG. 3 may transmit data at relatively high data rates within the limited bandwidth arena of home wiring by using ADSL modem technology to communicate between clients and servers rather than network cards. In contrast, as noted above, traditional approaches to this problem have been to provide full-blown Ethernet type peer-to-peer networking over home powerlines. The limited bandwidth of such an environment, however, limits the success of such an approach.

Moreover, the present invention allows for the use of “thin client” computers in the home. The cost of purchasing, maintaining, and upgrading four or more computers may be much more than all but the wealthiest homeowner can afford. The present invention allows a number of somewhat “dumb” client terminals to be installed, all running from a central server, thus reducing overall system cost, while providing access and computing power (e.g., internet access) for all family members at a number of different locations. While disclosed here as being used in a home environment, the present invention may also be implemented in a small office or other location where power line networking may be desired.

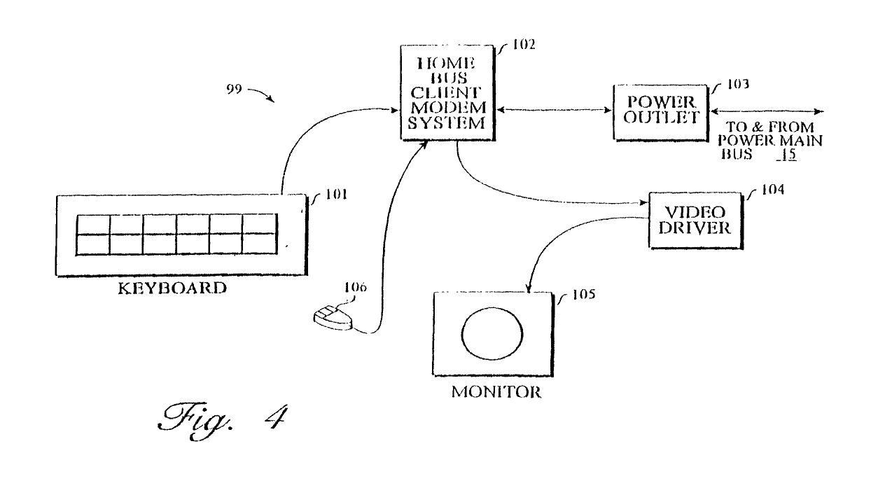

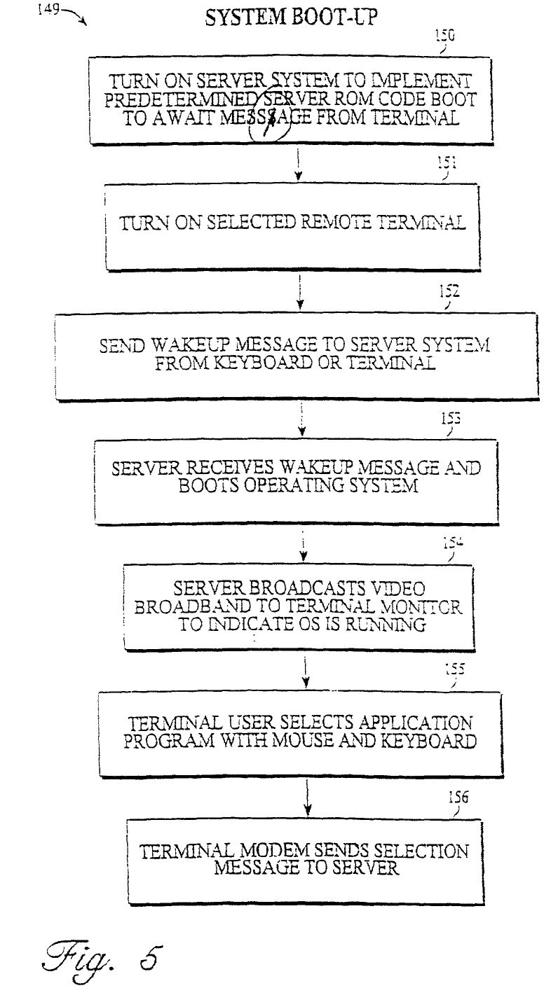

FIG. 4 is a block diagram of a terminal system including a keyboard, a home bus client modem system, a power outlet connected to the home bus client modem system and to and from the main power bus, a video driver, a monitor and a mouse. Terminal system 99 may include a keyboard 101, home bus client modem 102, and power output 103 connected to home bus client modem system 102 and to and from power bus system 15.

Video driver 104 may provide video signals for monitor 105. Video driver may be a limited capacity processor for receiving video pixel change information, storing such information, and generating video display data (analog or digital) for display on monitor 105. Monitor 105 may comprise a traditional CRT computer monitor, flat panel display, television (NTSC, HDTV, or the like) or other type display. Note that client terminal system 99 may be emulated by PC operating appropriate software. Thus, a home PC or laptop may be connected into the system in place of client terminal 99.

Monitor 105 receives video change data from video driver 104 which in turn received video change data from home bus client modem system 102. The change data may be derived from an application program at the server level which stores video data in successive frames which are compared with each other, pixel by pixel, to establish video change data. Keyboard 101 and mouse 106 may be connected to home bus client modem system 102 for reception of narrowband keyboard and mouse data which is in turn coded for transmission through power outlet 103 to power bus system 15 and server processing.

FIG. 5 is a flow chart describing system boot-up of the computer network system of the present invention. System boot-up 149 commences in step 150 where the server system is turned on to implement a predetermined server ROM boot code instructing it to wait for a message from a user terminal. Note than an applications or operating system software program may be used in place of a ROM boot code to implement the present invention, if so desired.

Next, a remote terminal is selected and turned on in step 151. In step 152 the selected remote terminal sends a wake-up message to the server system from a keyboard or other terminal appliance. The server system receives a wake up message and boots a selected operating system in step 153. Thereafter, the server broadcasts, in step 154, video broadband information to zero or more terminal monitors to indicate application program status and other information visually over a local monitor in a client terminal. In step 155, a user may select an application program using the mouse and/or keyboard. This mouse and keyboard information is sent upstream to the server in step 156 where the program will be executed.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A network for use over electrical power supply lines, the network comprising:
a server system for generating compressed video data and for transmitting the compressed video data over a power bus;
a power bus connected to said server system for receiving the compressed video data; and
at least one terminal coupled to said power bus for receiving compressed video data, decompressing the video data and displaying the video data on a local monitor, said at least one terminal further including an input device for receiving input signals from a user and for compressing the input signals as compressed input data and transmitting the compressed input data over the power bus,
wherein the power bus receives the compressed input data and transmits said compressed input data to said server system, said server system decompressing said input data and generating compressed video data in response to the input signals.

2. The network according to claim 1, wherein said server comprises:
a coder for generating the compressed video data as video change data; and
a first modem, for generating a first channel of compressed video data on the power bus.

3. The network according to claim 2, wherein said at least one terminal further comprises:
a second modem, for receiving the first channel of compressed video data from the power bus, and
a decoder for generating video data from the video change data received from the first channel of compressed video data.

4. The network according to claim 3, wherein said at least one terminal further comprises:
a coder for generating the compressed input data from the user input signals;
wherein said second modem in the at least one terminal generates a second channel of compressed input data on the power bus.

5. The network according to claim 4, wherein said first modem in said server receives the second channel of compressed input data from the power bus, and
wherein said server further comprises a decoder for generating input signals from the compressed input data from the second channel of compressed input data.

6. The network of claim 5, wherein said first channel is substantially larger in bandwidth than said second channel.

7. The network of claim 6, wherein said second channel are comprises a keyboard compressed data channel and a mouse compressed data channel, and wherein said user input signals comprise mouse and keyboard inputs.

8. A client terminal for used in a network coupled over electrical power supply lines, the network including a server system for generating compressed video data and for transmitting the compressed video data over a power bus and a power bus connected to said server system for receiving the compressed video data, said client terminal comprising:
at least one terminal coupled to said power bus for receiving compressed video data, decompressing the video data and displaying the video data on a local monitor, said at least one terminal further including an input device for receiving input signals from a user and for compressing the input signals as compressed input data and transmitting the compressed input data over the power bus,
wherein the power bus receives the compressed input data and transmits said compressed input data to said server system, said server system decompressing said input data and generating compressed video data in response to the input signals.

9. The client terminal according to claim 8, wherein the server includes a coder for generating the compressed video data as video change data and a first modem, for generating a first channel of compressed video data on the power bus, the client terminal further comprising:
a second modem, for receiving the first channel of compressed video data from the power bus, and
a decoder for generating video data from the video change data received from the first channel of compressed video data.

10. The client terminal according to claim 9, wherein said at least one terminal further comprises:
a coder for generating the compressed input data from the user input signals,
wherein said second modem generates a second channel of compressed input data on the power bus, and
wherein the first modem in the server receives the second channel of compressed input data from the power bus, the server further including a decoder for generating input signals from the compressed input data from the second channel of compressed input data.

11. The client terminal of claim 10, wherein said first channel is substantially larger in bandwidth than said second channel.

12. The client terminal of claim 11, wherein said second channel comprises a keyboard compressed data channel and a mouse compressed data channel, and wherein said user input signals comprise mouse and keyboard inputs.

13. A server for use with a network coupled over electrical power supply lines, the network including a power bus connected to the server for receiving and transmitting data, and at least one terminal coupled to the power bus for receiving and compressed video data from the power bus, decompressing the video data and displaying the video data on a local monitor, the at least one terminal further including an input device for receiving input signals from a user and for compressing the input signals as compressed input data and transmitting the compressed input data over the power bus, said server comprising:
a server system for generating compressed video data and for transmitting the compressed video data over the power bus;
wherein the power bus receives the compressed input data and transmits said compressed input data to said server system, said server system decompressing said input data and generating compressed video data in response to the input signals.

14. The server according to claim 13, wherein said server further comprises:
a coder for generating the compressed video data as video change data; and
a first modem, for generating a first channel of compressed video data on the power bus,
wherein the at least one terminal further comprises a second modem, for receiving the first channel of compressed video data from the power bus, and a decoder for generating video data from the video change data received from the first channel of compressed video data.

15. The server according to claim 14, wherein the at least one terminal further comprises a coder for generating the compressed input data from the user input signals, and the second modem generates a second channel of compressed input data on the power bus, and the first modem receives the second channel of compressed input data from the power bus, said server further comprising:
a decoder for generating input signals from the compressed input data from the second channel of compressed input data.

16. The server of claim 15, wherein said first channel is substantially larger in bandwidth than said second channel.

17. The server of claim 16, wherein said second channel comprises a keyboard compressed data channel and a mouse compressed data channel, and wherein said user input signals comprise mouse and keyboard inputs.
